(19) United States
(12) Patent Application Publication
(10) Pub. No.: US 2024/0379083 A1
(43) Pub. Date: Nov. 14, 2024

(54) DIGESTIVE-SAFE NOISE MAKING DEVICE

(71) Applicant: Grace Cole, Nathrop, CO (US)

(72) Inventor: Grace Cole, Nathrop, CO (US)

(21) Appl. No.: 18/655,242

(22) Filed: May 4, 2024

Related U.S. Application Data
(60) Provisional application No. 63/501,058, filed on May 9, 2023.

(51) Int. Cl. G10K 9/04; A01K 15/02; A63H 5/00; B29D 22/00

(52) U.S. Cl. CPC G10K 9/04; A01K 15/025; B29D 22/00; A63H 5/00; B29K 2995/0056

(57) ABSTRACT

The present application generally discloses a digestive-safe noise making device for placement in a product, such as a toy. The digestive-safe noise making device includes a wall forming a body. The body has a passable structure allowing for the passage of digestive material if ingested by a user. Passable structures presented herein include one or more kinks as well as one or more apertures. The passable structure prevents the noise making device from blocking digestive processes when traveling through or lodged within a portion of the GI tract. At least a portion of the noise making device may be made from digestible material.

### BACKGROUND

### 1. Field

Embodiments of the invention relate to toys. More specifically, embodiments of the invention relate to noise making devices for placement in toys.

### 2. Related Art

Many toys manufactured for the purpose of play include a noise making device, such as squeaker, to capture the toy user's attention and engage the user during playtime. Toys for children and toys for animals are known to include such squeakers. As an example, many dog toys of various structures and designs include a squeaker, with these toys often used as chew toys. Due to wear and tear of such chew toys that naturally occurs over various playtimes, the toy may break open and expose the squeaker. Additionally, dogs or other animals with a more aggressive nature of play may break open the toy and expose the squeaker. The animal playing with the toy may ingest the exposed squeaker. Once an animal ingests the squeaker, the squeaker may obstruct the gastrointestinal (GI) tract and subsequently block the user's digestive system. Blocking of the digestive system may cause a user discomfort, leading to vomiting, diarrhea, loss of appetite, lethargy, and abdominal pain. The blockage may even cause intestinal damage or, more severely, death. Surgery may be required to remove the squeaker from the user's digestive tract to stop the blockage.

A human child playing with a toy that contains a squeaker may also accidentally ingest the squeaker. For example, through similar wear and tear of the toy, the squeaker may become exposed, and the child may accidentally ingest the squeaker. Similar gastrointestinal issues to those discussed above could also occur when a child ingests a squeaker.

The field of toys would benefit from a squeaker that is made at least partially with digestible materials, such as a digestible plastic. If a user ingested such a squeaker, the squeaker would break down into smaller components that could safely pass through the gastrointestinal tract and eventually be excreted. Digestion of the squeaker material may take time, and thus the squeaker may not immediately break down to a size that is passable through the GI tract. Squeakers would also benefit from structural features that create a passage which food and bile or other digestive products could pass through prior to or during digestion of the squeaker material, such that the structure of the squeaker keeps the squeaker from blocking the digestive system.

### SUMMARY

Embodiments of the invention solve the above-mentioned problems by providing a device for generating a noise, such as a “squeak,” within a toy that allows digestive activity to proceed when the device is ingested by a user. The device may also be made at least partially of digestible material to promote digestion of the device so the device may be digestively processed in the GI tract and eventually excreted when the device is ingested by a user.

In some aspects, the techniques described herein relate to a noise making device, including: a wall forming a compressible body; a reed; a retaining member having a cavity extending therethrough, the retaining member integrally formed by the compressible body, wherein the cavity receives the reed such that the reed is fixedly attached to the retaining member; and a passable structure defined by the wall of the compressible body, wherein the passable structure is configured to allow for the passage of digestive material while the noise making device is located within a gastrointestinal tract of a user.

In some aspects, the techniques described herein relate to a noise making device for placement inside or on a product, the noise making device including: a wall forming a body, the wall including a digestible material; a housing including a reed; a retaining member integrally formed with the body, wherein the retaining member is integrally formed with the body at a junction, wherein the housing fixedly attaches to the retaining member; and an aperture-defining surface defining an aperture extending through the body, wherein the aperture-defining surface is formed by at least a portion of the wall, wherein the aperture is configured to allow the passage of digestive material upon ingestion of the noise making device by a user.

In some aspects, the techniques described herein relate to a method of manufacturing a noise making device for placement inside a toy, the method including: forming a hollowed structure via one or more manufacturing techniques, the hollowed structure forming a body, wherein the body is formed from a material; heating the material of the body to a temperature that allows the material to deform when forces are applied to the material; pressing a first tool and a second tool onto the body, wherein the first tool and the second tool are pressed onto the body from opposing directions; puncturing the body with the first tool and the second tool to create an aperture; heating the first tool and the second tool while the first tool and the second tool are puncturing the body; and sealing a wall of the aperture with the first tool and the second tool.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1A illustrates an exploded perspective view of an exemplary embodiment of a digestive-safe noise making device;

FIG. 1B illustrates a front view of the digestive-safe noise making device shown in FIG. 1A;

FIG. 1C illustrates a top view of the digestive-safe noise making device shown in FIGS. 1A-1B;

FIG. 2A illustrates a top view of the digestive-safe noise making device shown in FIGS. 1A-1C;

FIG. 2B illustrates a cross-sectional side view of the digestive-safe noise making device shown in FIGS. 1A-1C;

FIG. 2C illustrates a front view of the digestive-safe noise making device shown in FIGS. 1A-1C, with the reed removed;

FIG. 3 illustrates a top view of an exemplary embodiment of a digestive-safe noise making device;

FIG. 4 illustrates a top view of an exemplary embodiment of a digestive-safe noise making device;

FIG. 5A illustrates a top view of an exemplary embodiment of a digestive-safe noise making device in the x-y plane;

FIG. 5B illustrates a side view of an exemplary embodiment of a digestive-safe noise making device in the y-z plane;

FIG. 6A depicts a flowchart illustrating exemplary embodiments of a method of manufacturing a digestive-safe noise making device;

FIG. 6B illustrates some embodiments of the method depicted in FIG. 6A;

FIG. 6C illustrates some embodiments of the method depicted in FIG. 6A;

FIG. 7A illustrates a flowchart demonstrating an exemplary cycle of usage of a digestive-safe noise making device of some embodiments; and

FIG. 7B illustrates an exemplary embodiment of a digestive-safe noise making device lodged within a user's gastrointestinal tract.

The drawing figures do not limit the invention to the specific embodiments disclosed and described herein. The drawings are not necessarily to scale, emphasis instead being placed upon clearly illustrating the principles of the invention.

### DETAILED DESCRIPTION

The subject matter of the invention is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be understood by one skilled in the art and are intended to be captured within the scope of the claimed invention. Terms should not be interpreted as implying any particular ordering of various steps described unless the order of individual steps is explicitly described.

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

The terms “a,” “an,” and “the” do not denote a limitation of quantity but rather denote the presence of at least one of the referenced items. The terms “first,” “second,” “third,” and so forth may be used interchangeably to distinguish one item from another and are not intended to signify location or importance of the respective item. Range limitations in this description and in the claims include all endpoints, and all such endpoints are independently combinable to provide another range limitation.

The term “coupled,” when used herein with reference to at least two objects, refers to direct or indirect mechanical or physical contact between two objects in which the two objects are linked, connected, fastened, or joined with one another, including by way of an interference fit, one or more fastening elements or hardware, by adhesive, by bonding, by welding, or the like. The term “coupled” includes objects that are removably coupled with one another as well as objects that are permanently coupled to one another.

The term “integral” or “integrally formed,” when used herein with reference to at least two elements, refers to two elements that respectively define a portion, part, or piece of one and the same object, and/or two objects that are permanently coupled to one another such that the objects cannot be separated from one another without destructive means. The term “integral” includes a portion, part, or piece of an element that cannot be separated from the whole of the element without destructive means. For example, the term “integral” may refer to objects that are welded together, objects that are formed or cast as a single unit, as well as portions, parts, or pieces of a single, monolithic object.

Embodiments of the invention are directed to a noise making device for use in a toy that is safe for digestion such that the noise making device does not block digestive processes in the gastrointestinal tract if the user of the toy ingests the noise making device. The exemplary embodiments of a digestive-safe noise making device discussed below and in relation to the figures may be used in any toy, including toys for humans, dogs, or any other animal species. It is noted that the size of the exemplary embodiments of a digestive-safe noise making device may be modified according to the target user, such that the device is small enough to not cause a choking hazard and does not cause damage to the intestinal tissue of the intended user when the digestive-safe noise making device is ingested by a user. For example, the size of the exemplary embodiments of a digestive-safe noise making device may be smaller for a human baby than for a large-breed dog that has a larger gastrointestinal tract in comparison.

The present disclosure describes embodiments of digestive-safe noise making devices wherein the device may be made at least partially out of digestible material. This is advantageous because the noise making device is able to be broken down via digestion when in a gastrointestinal (GI) tract after a user ingests the noise making device. The break-down of the digestive-safe noise making device made of digestible material additionally decreases the size of the noise making device as the noise making device travels through the gastrointestinal tract, allowing the device to travel safely through the GI tract and keeping the noise making device from blocking digestive processes.

The present disclosure also describes embodiments of digestive-safe noise making devices wherein the shape of the noise making device provides passable structure allowing for the passage of food, bile, digestive products, or any combination thereof when the noise making device is lodged in an intestine or in a portion of a gastrointestinal tract (GI) after a user ingests the noise making device. This is advantageous because the shape of the noise making device keeps the digestive-safe noise making device from blocking digestive processes occurring in the gastrointestinal tract, thereby minimizing potential health issues that are associated with blockage of the gastrointestinal tract. Additionally, the noise making device shape described above and throughout the present application is also advantageous when implemented in a digestive-safe noise making device made at least partially of digestible material. The digestible material may not immediately be digested, and the breaking down of such digestible material may take a certain amount of time. In exemplary embodiments discussed below, the shape of the digestive-safe noise making device made of digestible material provides a passable structure for food, bile, and/or digestive products to travel through prior to the break-down of the digestible material or during digestion of the digestible material, such that the digestive-safe noise making device does not block digestive processes before or during the digestion of the digestible material.

These and other features of the presently disclosed subject matter are described with reference to the Figures.

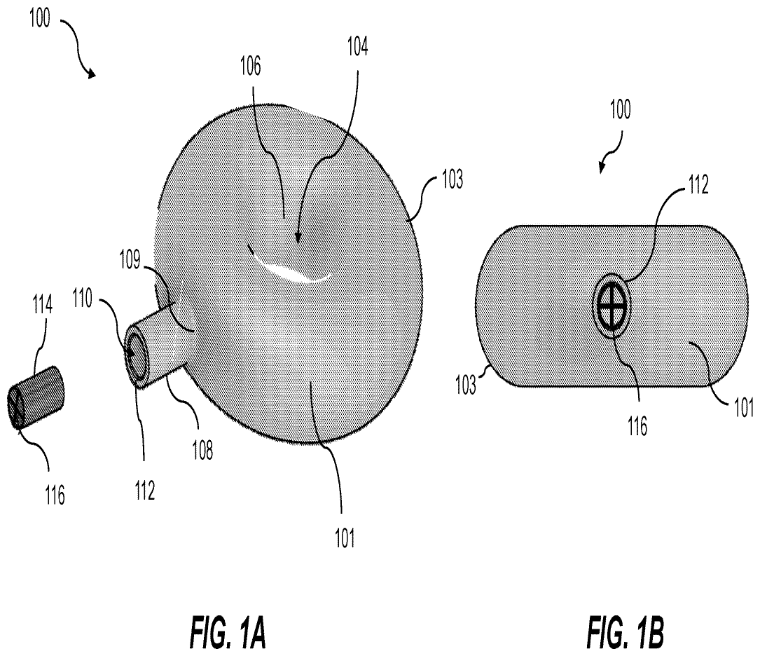

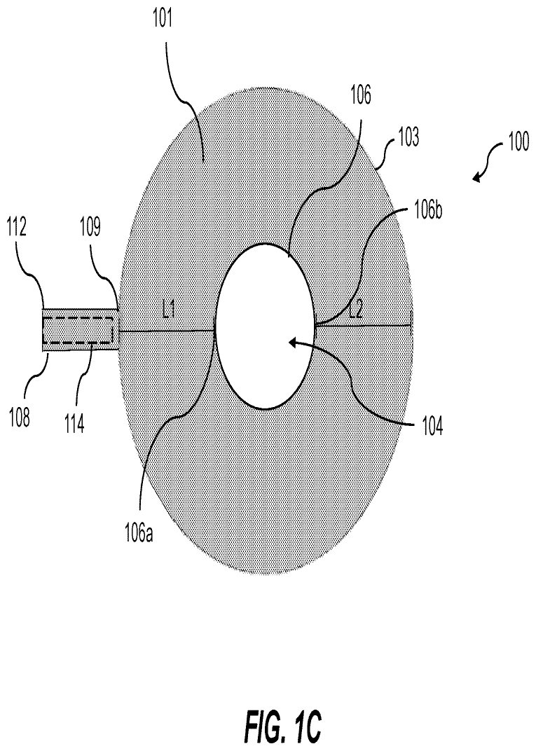

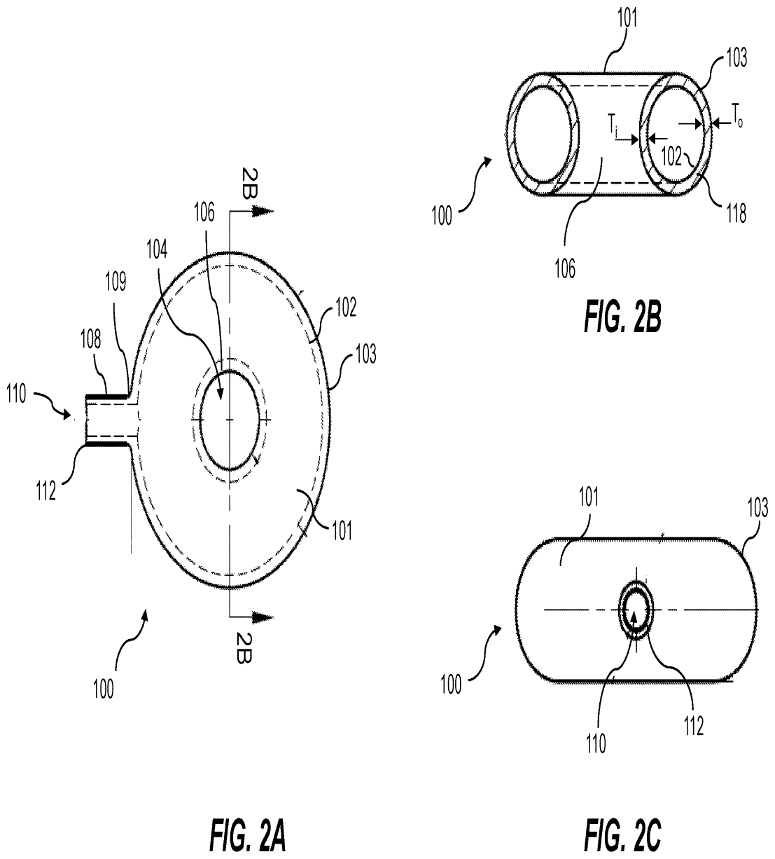

FIG. 1A shows an exploded perspective view of an exemplary embodiment of noise making device 100. Noise making device 100 may otherwise be referred to as a digestive-safe squeaker device or a digestive-safe noise making device herein. Noise making device 100 comprises a body 101 having an exterior surface 103. As can be seen in FIG. 2B and as further discussed below, the body 101 may be formed by a wall 118, with the wall 118 defining the exterior surface 103 of the body 101. Noise making device 100 may include a passable structure, such as aperture 104. Aperture 104 may be defined by at least a portion of the wall 118 of the body 101. The portion of the wall 118 defining the aperture 104 may otherwise be referred to as the aperture-defining surface 106, as shown in FIG. 1A. The aperture 104 provides an opening or passage for food, bile, and/or digestive products to pass through when noise making device 100 becomes lodged in a portion of a gastrointestinal (GI) tract after ingestion by a user. The aperture 104 of the noise making device 100 is configured to prevent noise making device 100 from blocking digestive processes in the GI tract, preventing health issues related to such digestive blockage from occurring in users who ingest noise making device 100.

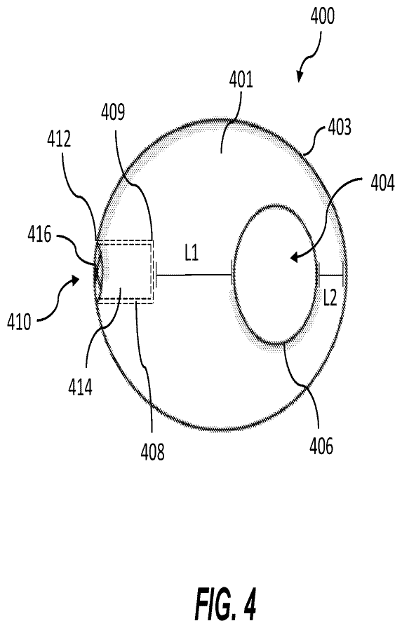

In some embodiments, and as depicted in FIG. 1A, a retaining member 108 may be integrally formed with the body 101 of noise making device 100. The body 101 and the retaining member 108 may be formed or cast as a single unit. A junction 109 defines a point at which the retaining member 108 meets with the exterior surface 103 of the body 101. The retaining member 108 may be integrally formed with the body 101 at the junction 109. In some embodiments, the retaining member 108 may be internally recessed within a hollow interior of the body 101 at the junction 109, as shown in FIG. 4.

As shown in FIGS. 1A and 1C, the retaining member 108 may protrude outwardly from the exterior surface 103 of the body 101, such that the retaining member 108 is positioned generally external from the body 101. The retaining member 108 may be substantially cylindrical in shape. In some embodiments, the retaining member 108 may be rectangular, triangular, or any other shape. As also illustrated in FIG. 2C, the retaining member 108 may define a cavity 110, with the cavity 110 extending through the retaining member 108. The cavity 110 defined by the retaining member 108 may be substantially cylindrical in shape. In some embodiments, the retaining member 108 may define a cavity 110 that is substantially rectangular, triangular, or any other shape. The cavity 110 may receive a housing 114. The housing 114 may comprise a reed 116 that is integrally formed therein. The housing 114 and the reed 116 may be any commercially available reed component that is used in a toy to produce noise, such as any commercially available reed used in a squeaker of a toy. The housing 114 may be fixedly attached to the retaining member 108 when received in the cavity 110. As the retaining member 108 may be integrally formed with the body 101, the housing 114 may be fixedly attached to the body 101 when received in the cavity 110. FIG. 1B shows the housing 114 received in the cavity 110 and fixedly attached to the retaining member interface 112. As in commonly used squeaker toys, when an adequate amount of air is forced through the housing 114 and reed 116 with sufficient velocity, the reed 116 produces a noise, such as a “squeak” sound. The reed 116 may align with a retaining member interface 112 comprised in the retaining member 108, as shown in FIGS. 1B and 1C.

In some embodiments, the noise making device 100 may be made of material considered to be non-digestible. In some embodiments, at least a portion of the noise making device 100 may be made of digestible material, such as plant-based digestible plastics. For example, at least a portion of the noise making device 100 may be made of a seaweed-based plastic material. In some embodiments, the housing 114 and reed 116 may be comprised of a digestible material. In some embodiments, the housing 114 and reed 116 may be comprised of non-digestible materials, as the housing 114 and reed 116 may be small enough to pass safely through the GI tract and be excreted without blocking digestive processes or damaging tissues within the GI tract. In some embodiments, the noise making device 100 may be comprised of a combination of digestible material and non-digestible material. For example, noise making device 100 may be made of a plant-based digestible plastic, rubber, PVC, nylon, thermoplastic, thermoset, or any combination of the described materials. The digestible material of the noise making device 100 may be digested and broken down when the noise making device 100 is ingested by a user into the user's GI tract, thereby decreasing the size of the noise making device 100 such that the noise making device 100 may safely pass through a GI tract without getting stuck or lodged within the GI tract. The decreased size of the noise making device 100 may prevent blockage or obstruction of digestive processes in the GI tract, as food, bile, and/or digestive products may pass through or around noise making device 100 when lodged in a portion of the GI tract. The decreased size of the noise making device 100 may also decrease the amount of pain felt by the user while the noise making device 100 moves through the GI tract, as the smaller size of the noise making device 100 may inflict less damage on intestinal tissue or prevent tissue damage from occurring.

FIG. 1C shows a top view of the noise making device 100 of FIGS. 1A-1B. As shown in FIG. 1C, the body 101 may be substantially circular in shape. The circular shape of the body 101 may allow the body 101 to expand equally in all directions when lodged in the GI tract of a user after user ingestion of the noise making device 100. The circular shape of the body 101 may expand the body 101 an equal amount in each direction when in the GI tract. The circular shape of the body 101 may also decrease the amount of tissue damage the GI tract may incur, as the smooth exterior forming the circular shape would not cut or scrape tissue in the GI tract. In some embodiments, the body 101 may be substantially rectangularly shaped, oval-shaped, ellipse-shaped, or any other shape.

The aperture 104 of the body 101 may be substantially circular in shape, as shown in FIG. 1C. The circular-shaped aperture 104 may provide structural integrity such that the aperture 104 does not deform and potentially close when the noise making device 100 is in the GI tract. The aperture-defining surface 106 may be generally arcuately-shaped, as shown in FIGS. 1A and 1C. The arcuate shape of the aperture-defining surface 106 may evenly distribute any forces applied to the aperture-defining surface 106 while the noise making device 100 is stuck in the GI tract or traveling through the GI tract. This even distribution of forces allows the aperture-defining surface 106 to maintain structural integrity such that the aperture 104 remains open for food, bile, and/or digestive products to pass through and does not deform or collapse. The combination of the aperture 104 and body 101 may form a generally donut-like shape, as shown in FIG. 1C.

The dashed lines shown in FIG. 1C depict the outline of the housing 114 when fixedly attached to the retaining member 108 and received in cavity 110. FIG. 1C shows the aperture 104 of the noise making device 100 being a first distance L₁ away from the junction 109 of the retaining member and a second distance L₂ away from a portion of the exterior surface 103 oppositely positioned to the junction 109. The first distance L₁ is defined by the distance from a first portion 106a of the aperture-defining surface 106 to the junction 109. The second distance L₂ is defined by the distance from a second portion 106b of the aperture-defining surface 106, that is located opposite to first portion 106a of the aperture-defining surface 106 defining the first distance L₁, to a portion of the exterior surface 103 that is oppositely positioned to the junction 109. The first distance L₁ and the second distance L₂ define the position of the aperture 104 with respect to the body 101. As shown in FIG. 1C, the first distance L₁ and the second distance L₂ may be equal such that the aperture 104 is positioned in the center of the body 101.

The placement of the aperture 104 within the body 101, being defined by the first distance L₁ and the second distance L₂, may affect the structural integrity of the aperture-defining surface 106. Additionally, the placement of the aperture 104 within the body 101 may affect the ability of the noise making device 100 to produce an audible sound, such as a squeak. For example, as shown in FIG. 1C, the aperture-defining surface 106 defines the aperture 104 at an equal distance from the junction 109 (i.e., first distance L₁) and from the portion of the exterior surface 103 positioned opposite the junction 109 (i.e., second distance L₂). This equidistant placement of the aperture 104 may provide equal amounts of structural support along the aperture-defining surface 106, as the volume of the body 101 is equally dispersed around the aperture-defining surface 106. The equally dispersed volume of the body 101 about the aperture-defining surface 106 may distribute the forces or pressures applied to the noise making device 100 evenly around the aperture-defining surface 106 when the noise making device 100 is traveling through or stuck within the GI tract. The even distribution of the forces and pressures may keep the aperture-defining surface 106 (and subsequently, aperture 104) from deforming, thereby keeping the aperture 104 open such that food, bile, and/or digestive products can pass through the noise making device 100 when ingested into a GI tract.

The aperture-defining surface 106 defining the aperture 104 at an equal distance from the junction 109 (i.e., first distance L₁) and from the portion of the exterior surface 103 oppositely positioned to the junction 109 (i.e., second distance L₂) may affect the ability of noise making device 100 to make a sound when the body 101 is deformed or pressed. For example, as shown in FIG. 1C, the equidistant placement of the aperture 104 affects the dispersion of air within the internal space of noise making device 100 when in the fully expanded configuration (i.e., full of air). Such dispersion of internal air may affect the rate at which air travels through housing 114 and reed 116 upon compression of noise making device 100. Accordingly, embodiments disclosed herein include multiple considerations of the location of aperture 104 with respect to body 101. For example, in some embodiments the first distance L₁ may be greater than the second distance L₂, such that a greater amount of volume of the body 101 is placed closer to the reed 116. An exemplary embodiment of a noise making device 400 is illustrated in FIG. 4 having an aperture 404 defined by an aperture-defining surface 406 and located with first distance L₁ being greater than second distance L₂. With the aperture 404 positioned farther from the housing 414, as shown in FIG. 4, there is a greater amount of volume of the body 401 closer to the housing 414 than the amount of volume close to the housing 114 in FIG. 1C. Such a configuration may allow for an increased rate of air flow through the reed 416 of the housing 414 as pressure is exerted on body 401, which may increase the likelihood of noise making device 400 generating a noise.

FIG. 2A illustrates a top view of the exemplary embodiment of the noise making device 100 shown in FIGS. 1A-1C. The dashed lines in FIG. 2A depict a wall 118 forming the body 101 and the interior surface 102. In some embodiments, the diameter of the aperture 104 may be between about 0.5 inches to about 1 inch. The diameter of the body 101 may be between about 1.5 inches to about 3 inches. A ratio of the diameter of the aperture 104 in relation to the diameter of the body 101 may be between about 0.25 to about 0.6. For example, a ratio of 0.3 equates roughly to the diameter of the aperture 104 being ⅓ the diameter of the body 101. The size of the aperture 104 in relation to the size of the body 101 affects the ability of the noise making device 100 to make noise. For example, when the ratio of the diameter of the aperture 104 to the diameter of the body 101 is too large, the body 101 may not have enough volume to hold an adequate amount of air to push through the housing 114 and reed 116 to generate a noise. Alternatively, when the ratio of the diameter of the aperture 104 to the diameter of the body 101 is too low, the size of the aperture 104 may be too small to allow the passage of digestive materials when lodged into the GI tract.

FIG. 2B shows a cross-sectional side view of the exemplary embodiment of the noise making device 100 shown in FIGS. 1A-2A, the location of the cross-section indicated by the line and arrows labeled 2B in FIG. 2A. The diagonal lines depict the wall 118 and the dashed lines distinguish the wall 118 from the hollow interior of the body 101 that is defined by the wall 118. As can be seen in FIG. 2B, the wall 118 defines the aperture-defining surface 106. Further, the wall 118 defines the exterior surface 103 and interior surface 102. As indicated in FIG. 2B, the wall 118 may have a first thickness Tᵢ defined by a portion of the exterior surface 103 and a portion of the interior surface 102 that form the aperture-defining surface 106. Also as indicated in FIG. 2B, the wall 118 may have a second thickness Tₒ defined by a portion of the exterior surface 103 that is directly opposite the portion of the exterior surface 103 forming the aperture-defining surface 106 and defined by a portion of the interior surface 102 that is directly opposite the portion of the interior surface 102 forming the aperture-defining surface 106. Said another way, the first thickness Tᵢ may define the thickness of the aperture-defining surface 106 formed by the wall 118 and the second thickness Tₒ may define the thickness of a portion of the wall 118 that is directly opposite the aperture-defining surface 106.

In some embodiments, the first thickness Tᵢ of the aperture-defining surface 106 formed by the wall 118 and a second thickness Tₒ of a portion of the wall 118 directly opposite the aperture-defining surface 106 may be equal, such that the wall 118 has an even thickness throughout, as shown in FIG. 2B. The first thickness Tᵢ and second thickness Tₒ may be between about 0.02 inches and about 0.5 inches. In some embodiments, the first thickness Tᵢ and the second thickness Tₒ may comprise different thicknesses. For example, in some embodiments, the first thickness Tᵢ may be greater than the second thickness Tₒ, such that the wall 118 has a variable thickness throughout. In some embodiments, the second thickness Tₒ may be greater than the first thickness Tᵢ. In some embodiments, the overall thickness of the wall 118 may gradually change between the first thickness Tᵢ to the second thickness Tₒ, thereby creating a gradient of thickness between the aperture-defining surface 106 and the portion of the wall directly opposite the aperture-defining surface 106. As will be discussed in greater detail below, variable thicknesses of the wall 118 between first thickness Tᵢ and second thickness Tₒ may be formed during the manufacturing process (e.g., during manufacturing process 600). For example, in some embodiments a mold may be used that forms a variable thickness of wall 118 while forming noise making device 100. In some embodiments, one or more layers (e.g., reinforcement piece 630) may be molded, adhered, or otherwise attached to the aperture-defining surface 106 such that first thickness Tᵢ is greater than second thickness Tₒ. Additionally, or alternatively, one or more layers may be molded, adhered, or otherwise attached to a portion of wall 118 forming the second thickness Tₒ such that the thickness of second thickness Tₒ is increased compared to first thickness Tᵢ.

In some embodiments, a thicker wall defining the aperture-defining surface 106 may enhance structural integrity to the aperture-defining surface 106, thereby mitigating deformation of the aperture 104 due to forces and pressures exerted while in the GI tract. Increasing the structural integrity of the aperture-defining surface 106 may keep the aperture 104 open such that food, bile, and/or digestive products pass through the noise making device 100 while traveling within or lodged within the GI tract. In some embodiments not shown here, one or more structural beams may cross from one portion of the aperture-defining surface 106 to another oppositely positioned portion of the aperture-defining surface 106 to increase the structural integrity of the aperture-defining surface 106 to mitigate deformation of the aperture 104 such that food, bile, and/or digestive products may pass through.

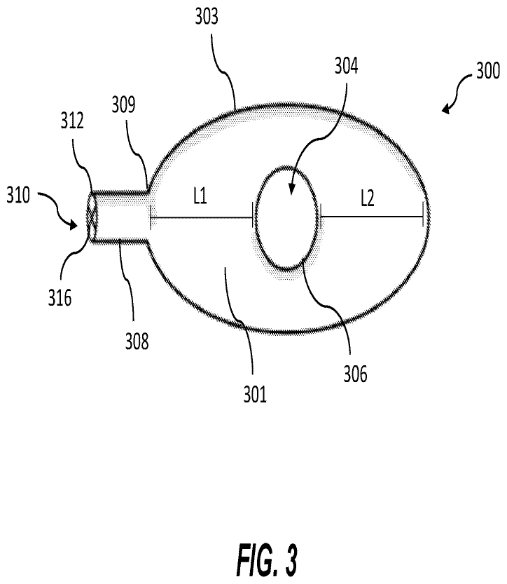

FIG. 3 illustrates a top view of an exemplary embodiment of a noise making device 300. The body 301 is generally ellipse shaped. In some embodiments, the first distance L₁ and the second distance L₂ may be equal, such that the aperture-defining surface 306 defines the aperture 304 at an equal distance from the junction 309 to a portion of the aperture-defining surface 306 (i.e., first distance L₁) and from a portion of the exterior surface 303 positioned directly opposite the junction 309 to a portion of the aperture-defining surface 306 directly opposite the portion of the aperture-defining surface 306 defining the first distance L₁ (i.e., second distance L₂). In some embodiments, as discussed above and below in relation to FIGS. 4, L₁ and L₂ may comprise different distances such that aperture 304 is not equidistant from junction 309 and a portion of the exterior surface 303 positioned directly opposite junction 309. In some embodiments, the housing (not depicted) and reed 316 connected thereto are received in the cavity 310 formed by the retaining member 308. The reed 316 aligns with the retaining member interface 312.

FIG. 4 illustrates a top view of an exemplary embodiment of a noise making device 400, wherein the body 401 is generally ellipse shaped. As discussed above, in some embodiments the first distance L₁ is greater than the second distance L₂, such that the aperture 404 is generally closer to the portion of the exterior surface 403 directly opposite the junction 409 than to the junction 409. The dashed lines depict the outlines of the retaining member 408 and the housing 414 received in the cavity 410 of the retaining member 408. As shown in FIG. 4, in some embodiments the retaining member 408 may be formed internally in the body 401, such that the cavity 410 formed by the retaining member 408 recesses into a hollow interior of the body 401 and the retaining member interface 412 is substantially aligned with exterior surface 403. The retaining member 408 may generally form a recess in the body 401. The structure of the retaining member 408 may affect the internal volume of noise making device 400, and thus affect the loudness of the noise generated by the reed 416 in the housing 414 and/or the likelihood of noise making device 400 to generate a noise.

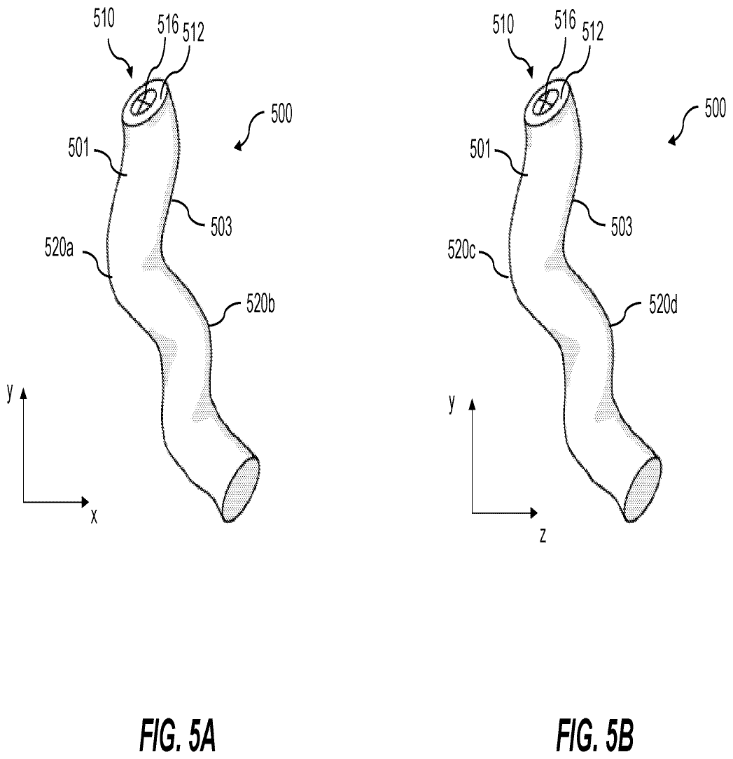

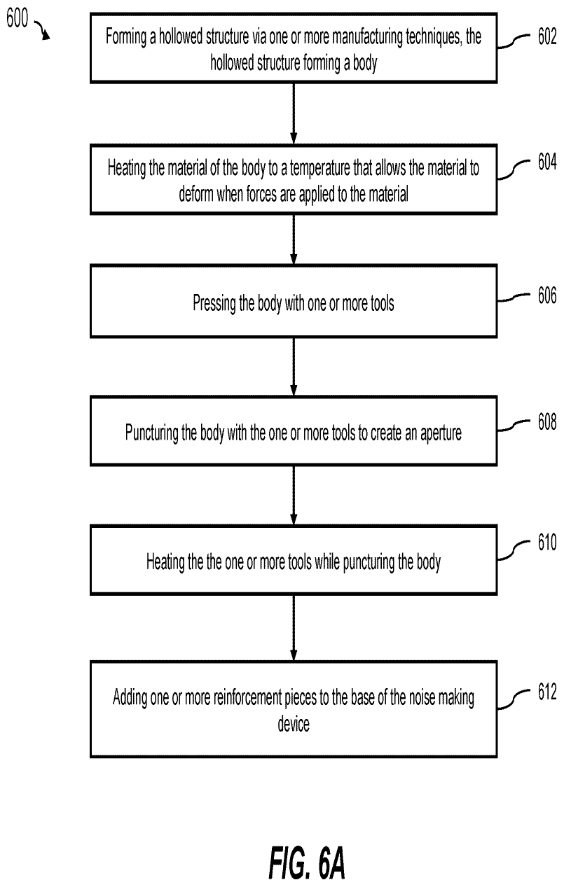

FIG. 5A illustrates a top view of an exemplary embodiment of a noise making device 500, with the top view illustrating the x-y plane. The body 501 of noise making device 500 may extend longitudinally along the y-axis. The noise making device 500 may contain components similar to those described in other exemplary embodiments, such as a reed 516 comprised in a housing (not shown), a retaining member interface 512, a retaining member (not shown) having a cavity 510 extending therethrough, and a body 501 having an exterior surface 503. In some embodiments, the body 501 may include a passable structure that allows for the passage of digestive material while noise making device 500 is lodged within the GI tract of a user. For example, noise making device 500 may include one or more kinks (e.g., first kink 520a and second kink 520b). In some embodiments, the first kink 520a may turn outwardly in a first direction and the second kink 520b may turn outwardly in a second direction generally opposite the first direction. As illustrated, the direction of first kink 520a and the direction of second kink 520b may be directed along the x-axis and outwardly from the longitudinal y-axis.

FIG. 5B illustrates a side view of an exemplary embodiment of noise making device 500, with the side view illustrating the y-z plane. As can be seen in FIG. 5B, the body 501 may include one or more kinks along the z-axis (e.g., third kink 520c and fourth kink 520d). The third kink 520c may turn outwardly in a first direction and the fourth kink 520d may turn outwardly in a second direction generally opposite the first direction. As illustrated, the direction of third kink 520c and the direction of fourth kink 520d may be directed along the z-axis, such that the body 501 has kinks directed in multiple dimensions outwardly from the y-axis of the body 501. For example, first kink 520a and second kink 520b extend outwardly in the x-axis and third kink 520c and fourth kink 520d extend outwardly in the z-axis, with the x-axis being substantially perpendicular to the z-axis. The three-dimensional passable structure formed by kinks 520a-d may provide openings for food, bile, and/or digestive products to pass through when the noise making device 500 is traveling or lodged within the GI tract of a user, independent of the orientation the noise making device 500 travels through the GI tract therein. Said another way, the kinks 520a-d of noise making device 500 precludes blockage of food, bile, or other digested material by noise making device 500.

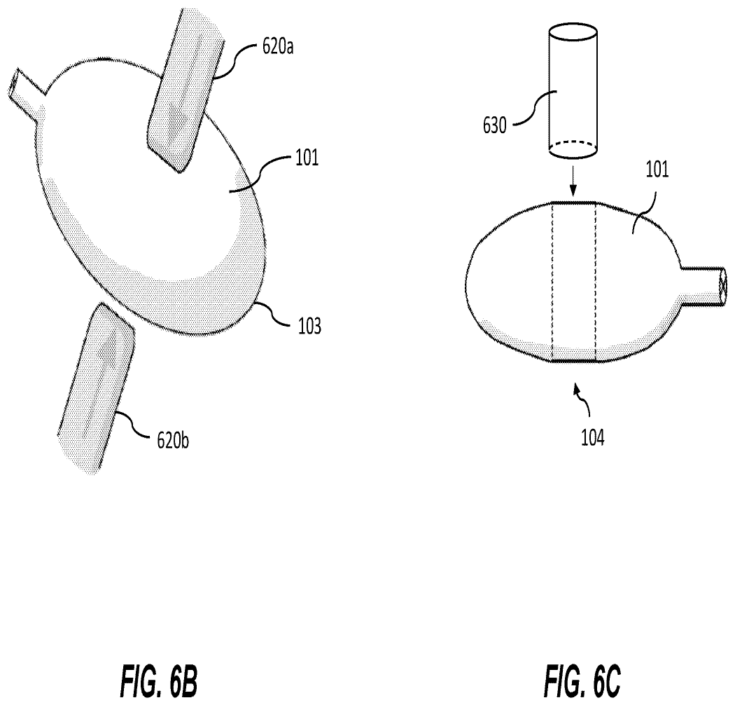

FIG. 6A is a flow chart illustrating a manufacturing process 600 for a noise making device (e.g., noise making device 100, noise making device 300, noise making device 400, and/or noise making device 500). For clarity purposes, the below steps may reference a single noise making device (e.g., noise making device 100), but it is to be understood that any one more steps may be used to form embodiments disclosed herein of a digestible noise making device.

In a step 602, one or more manufacturing techniques are performed to form the hollow structure of a body of a noise making device. For example, additive manufacturing may be performed to form body 101 of noise making device 100. Additionally, or alternatively, other manufacturing techniques such as 3D printing, extrusion, injection molding, thermoforming, rotational molding, blow molding, or other may be used alone or in combination to form body 101 of noise making device 100. In some embodiments, and as described above, the material of the body 101 may comprise a digestible plastic (such as a seaweed-based plastic), rubber, PVC, nylon, thermoplastic, thermoset, or any combination of the described materials.

In a step 604, the hollow structure is heated to increase malleability of the structure. For example, the material of the body 101 may be heated to a temperature (e.g., 65° C. to 100° C.) that allows the material to deform when forces are applied to the material. In some embodiments, the heat used is based on the material of body 101, such as those described above.

In a step 606, one or more tools may be pressed against the body of the noise making device. For example, once the material of the body 101 has been heated to a temperature sufficient to make body 101 malleable, a first tool (e.g., first tool 620a) and a second tool (e.g., second tool 620b) are pressed onto opposing portions of the exterior surface 103 of the body 101. FIG. 6B illustrates the first tool 620a and the second tool 620b moving in opposite directions toward the exterior surface 103 of the body 101. While first tool 620a and second tool 620b are illustrated as roughly circular at the pressing end, it is noted that first tool 620a and second tool 620b may be any shape. For example, first tool 620a and second tool 620b may comprise a half circular, crescent, polygonal, or any other shape. As stated below with reference to steps 608 and 610, altering the shape of first tool 620a and second tool 620b will subsequently alter the shape of aperture 104.

In a step 608, one or more tools puncture the body of the noise making device. For example, the first tool 620a and second tool 620b puncture the exterior surface 103 of the hollow structure of the body 101 to create aperture 104.

In a step 610, the one or more tools are heated while pressing and/or puncturing the body of the noise making device. For example, the first tool 620a and the second tool 620b may be heated to a temperature that deforms the material of the body 101 while the first tool 620a and the second tool 620b are puncturing the exterior surface 103 of the body 101. In some embodiments, heating of the first tool 620a and second tool 620b may aid in puncturing the material of body 101. In some embodiments, the heating of the first tool 620a and second tool 620b may seal the punctured edges of the material of body 101. Such puncturing and sealing may occur simultaneously, or mostly simultaneously. Thus, in steps 608 and 610, the aperture 104 may be formed by puncturing the body 101 while also forming the aperture-defining surface 106 by sealing the punctured edges.

In a step 612, one or more reinforcement pieces may be added to the body of the noise making device. For example, in some embodiments additional material may be applied to the aperture-defining surface 106 and molded thereto. In some embodiments, a reinforcement piece 630 illustrated in FIG. 6C, comprising the same or different material from body 101, is inserted through aperture 104. Following proper placement of reinforcement piece 630, a sealing process is performed to adhere reinforcement piece 630 to aperture-defining surface 106. While reinforcement piece 630 is depicted as mostly cylindrical, it is contemplated that reinforcement piece 630 may comprise any shape allowing for reinforcement piece 630 to be readily adhered or otherwise molded to a specific area of exterior surface 103, such as aperture-defining surface 106. As discussed above, the use of one or more reinforcement pieces (e.g., reinforcement piece 630), or increasing the thickness of wall 118 in another way, may provide enhanced rigidity to that area. For example, by molding reinforcement piece 630 to aperture-defining surface 106, may aid in precluding deformation of aperture 104 when noise making device 100 is lodged in the GI tract.

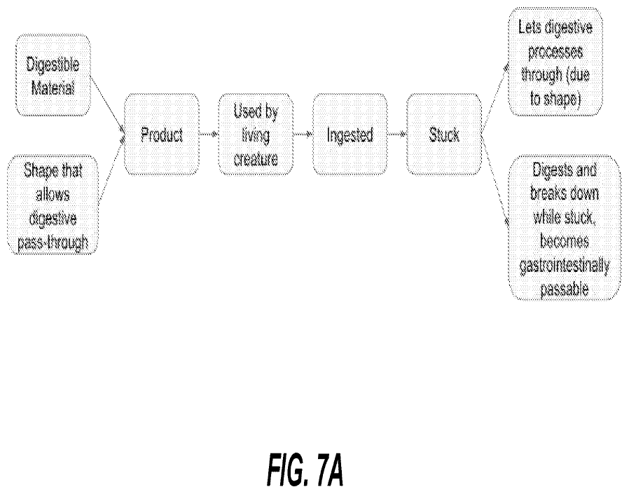

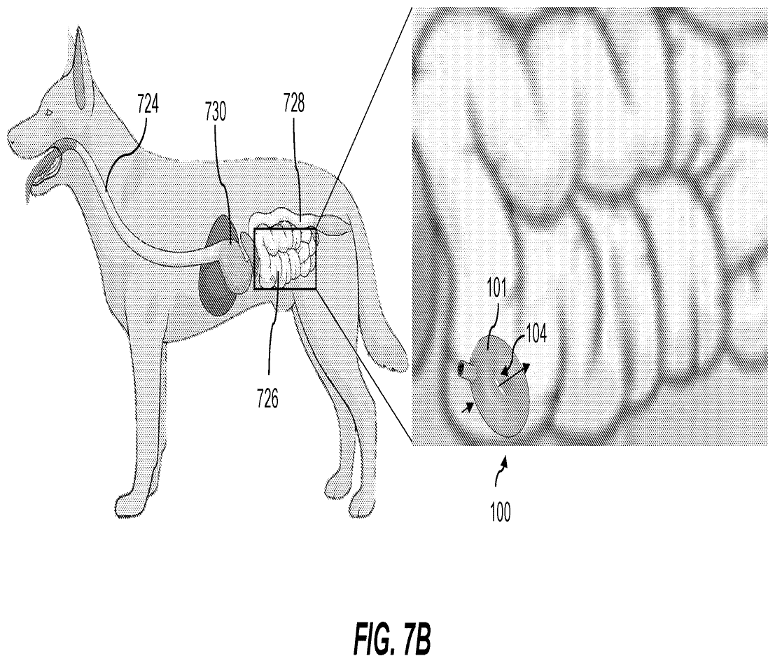

FIG. 7A shows an exemplary cycle of usage of some embodiments disclosed herein of a digestive-safe noise making device. As discussed previously, the noise making device 100 may be formed at least partially from a digestible material, such as a seaweed-based digestible plastic. The noise making device 100 may include a passable structure to allow digestive processes to pass through the noise making device 100 when the noise making device 100 is ingested by a user. For example, the body 101 of the noise making device 100 may form an aperture 104 that provides an opening for food, bile, and/or digestive products to pass through when the noise making device 100 is ingested into a GI tract. The noise making device 100, once manufactured, may then be placed in a product, such as a dog toy. The noise making device 100 may also be inserted in any toy for any type of user, including a human child, a cat, a bunny, or any other animal. In some embodiments, the noise making device 100 may be inserted into accessories for babies to wear and/or interact therewith.

As shown in the diagram of FIG. 7A, a living creature (i.e., user) using the toy or other product containing the noise making device 100 may ingest the noise making device 100. When ingested, the noise making device 100 may become lodged or stuck within the GI tract of the user, which may cause pain or discomfort to the user. While stuck, the passable structure of the noise making device 100 may allow digestive processes to pass through the device 100 to minimize the pain, discomfort, and medical issues associated with ingesting a squeaker device prior to and during digestion of the digestible material. The material of the noise making device 100 may additionally be digested within the user's GI tract while the noise making device 100 is stuck, such that the noise making device 100 is broken down into small portions. Such digestive processes eventually dislodge the noise making device 100, or portions thereof, from the stuck position and allow the user to comfortably excrete digestive byproducts of the noise making device 100.

For illustrative purposes, FIG. 7B depicts a scenario similar to that described above with regards to FIG. 7A, wherein some embodiments of a noise making device disclosed herein becomes stuck in the GI tract (e.g., a small intestine 726) of a dog. As shown in FIG. 7B, a noise making device (e.g., noise making device 100), as disclosed in the present application, has a passable structure that allows digestive processes to pass through the noise making device 100. For example, as shown in FIG. 7B the body 101 of the noise making device 100 may comprise an aperture 104 that provides an opening for food, bile, and/or digestive products to pass through, as indicated by the arrows passing through the aperture 104. The noise making device 100 may allow digestive processes to occur when the noise making device 100 is traveling through or lodged in the small intestine 726, large intestine 728, stomach 730, esophagus 724, or other portion of the user's GI tract.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A noise making device, comprising:
a wall forming a compressible body;
a reed;
a retaining member including a cavity extending therethrough, the retaining member integrally formed by the compressible body,
wherein the cavity receives the reed such that the reed is fixedly attached to the retaining member; and
a passable structure defined by the wall of the compressible body,
wherein the passable structure is configured to allow for passage of digestive material while the noise making device is located within a gastrointestinal tract of a user.

2. The noise making device of claim 1, wherein the compressible body defines a longitudinal axis, and wherein the passable structure comprises one or more kinks extending outwardly from the longitudinal axis of the compressible body.

3. The noise making device of claim 2, wherein the one or more kinks comprises at least a first kink and a second kink, wherein the first kink extends outwardly from the longitudinal axis in a first direction and the second kink extends outwardly from the longitudinal axis in a second direction, the first direction and the second direction being perpendicular to one another.

4. The noise making device of claim 1, wherein the passable structure comprises an aperture extending through the compressible body.

5. The noise making device of claim 4, wherein the wall further comprises:
an exterior surface and an interior surface,
wherein at least a portion of the interior surface and at least a portion of the exterior surface define the aperture,
wherein the portion of the interior surface and the portion of the exterior surface defining the aperture comprise an aperture-defining surface.

6. The noise making device of claim 5, wherein the aperture-defining surface comprises a first thickness and at least a portion of the wall positioned directly opposite the aperture-defining surface comprises a second thickness, wherein the first thickness is greater than the second thickness.

7. The noise making device of claim 5, wherein the aperture-defining surface defining the aperture is generally arcuately-shaped, such that the aperture is generally circular-shaped.

8. The noise making device of claim 1, wherein the retaining member protrudes generally outward from the compressible body.

9. The noise making device of claim 1, wherein the wall defines a generally hollow interior of the compressible body, and wherein the retaining member generally forms a recess in the compressible body, such that the cavity recesses into the generally hollow interior of the compressible body.

10. The noise making device of claim 1, wherein the retaining member further comprises:
a retaining member interface,
wherein the reed aligns with the retaining member interface when the reed is fixedly attached in the cavity.

11. The noise making device of claim 1, wherein the compressible body is at least partially made from a digestible material.

12. A noise making device for placement inside or on a product, the noise making device comprising:
a wall forming a body, the wall comprising a digestible material;
a housing comprising a reed;
a retaining member integrally formed with the body,
wherein the retaining member is integrally formed with the body at a junction,
wherein the housing fixedly attaches to the retaining member; and
an aperture-defining surface defining an aperture extending through the body,
wherein the aperture-defining surface is formed by at least a portion of the wall,
wherein the aperture is configured to allow passage of digestive material upon ingestion of the noise making device by a user.

13. The noise making device of claim 12, wherein the aperture-defining surface has a first thickness and at least a portion of the wall positioned directly opposite the aperture-defining surface has a second thickness, wherein the first thickness and the second thickness comprise an equal thickness.

14. The noise making device of claim 12, wherein the portion of the wall defining the aperture is generally arcuately-shaped such that the aperture is generally circular-shaped, and wherein the body is generally circular-shaped.

15. The noise making device of claim 12, wherein the wall has an exterior surface and an interior surface, and wherein the aperture-defining surface defines the aperture at a first distance from the junction and at a second distance from a portion of the exterior surface positioned directly opposite the junction.

16. The noise making device of claim 15, wherein the first distance is greater than the second distance.

17. The noise making device of claim 12, wherein the retaining member further comprises:
a retaining member interface and a cavity extending through the retaining member,
wherein the reed aligns with the retaining member interface when the housing is fixedly attached in the retaining member.

18. A method of manufacturing a noise making device, the method comprising:
forming a hollowed structure via one or more manufacturing techniques, the hollowed structure forming a body,
wherein the body is formed from a material;
heating the material of the body to a temperature that allows the material to deform when forces are applied to the material;
pressing a first tool and a second tool onto the body,
wherein the first tool and the second tool are pressed onto the body from opposing directions;
puncturing the body with the first tool and the second tool to create an aperture;
heating the first tool and the second tool while the first tool and the second tool are puncturing the body; and
sealing a wall of the aperture with the first tool and the second tool.

19. The method of claim 18, wherein at least a portion of the material of the body comprises a digestible plastic.

20. The method of claim 18, further comprising:
adhering a reinforcement piece to the wall of the aperture.
